(19) United States
(12) Patent Application Publication
(10) Pub. No.: US 2003/0030874 A1
(43) Pub. Date: Feb. 13, 2003

(54) Method and system for amplitude modulation of an optical signal

(76) Inventors: Christoph Glingener, Feldkirchen-Westerham (DE); Erich Gottwald, Holzkirchen (DE)

Correspondence Address: BELL, BOYD & LLOYD, LLC, P. O. BOX 1135, CHICAGO, IL, 60690-1135, US

(21) Appl. No.: 10/239,031

(22) PCT Filed: Feb. 15, 2001
(86) PCT No.: PCT/DE01/00580

(30) Foreign Application Priority Data
Mar. 17, 2000 (DE) 100 13 197.2

(51) Int. Cl. H04B 10/04

(52) U.S. Cl. 359/181; 359/180

(57) ABSTRACT

The invention relates to a method and to a system for amplitude modulation of an optical signal (os) with a binary data signal (ds). To this end, the optical signal (os) is divided up into a first and a second adjustable optical signal (os1, os2). The first optical signal (os1) is supplied to a modulator (MZM) that outputs an optical transmission signal (ts) after amplitude modulation with a binary data signal (ds). A counter-phase second optical signal (gps) is produced from the second adjustable optical signal (os2) and the optical transmission signal (ts) and the counter-phase second optical signal (gps) are combined to a carrier-reduced optical transmission signal (rts).

The present invention relates to a method and configuration for modulating the amplitude of an optical signal with a binary data signal which is supplied to a modulator for purposes of generating an optical transmission signal.

In optical transmission systems with data rates of 20 Gbit/s and above, particularly in optical long-range communication systems with optical amplifiers, given digital amplitude modulated optical signals (i.e. transmission signals) a low extinction ratio contributes to the degradation of the optical signal-to-noise ratio (OSNR), which is needed for reconstructing the data on the reception side. The extinction ratio derives from the power ratio between logical 0 signal power and logical 1 signal power; that is, an amplitude modulated signal with a high continuous wave component (i.e. carrier component) in excess of half the overall power of the optical transmission signal has a low extinction ratio, and a signal that has beenfully modulated almost completely has a very high extinction ratio. For instance, if the extinction ratio of the amplitude modulated optical signal in a communication system with optical amplifiers is 3 dB, then the OSNR which is needed in order to receive the amplitude modulated optical signal correctly is higher by more than a factor of ten than it would be given an extinction ratio of 20 dB. This shortens the transmission distance that can be bridged without regeneration appreciably, by approximately one order of magnitude.

Given the state of the art at present, the ability to achieve a high extinction ratio given extremely high data rates (40 Gbit/s and upward) is very limited and financially costly to realize.

Because neither the direct modulation of a laser nor a modulation with electroabsorption modulators is expedient for such high data rates in the present state of the art, Mach Zehnder modulators (MZM) or Mach Zehnder Interferometers (MZI) are employed for this purpose. Besides the modulation signal, MZM modulators generally require a high drive voltage of between 6 Volts and 2×6 Volts in order to realize the high extinction ratio which is needed for a successful transmission. The drive circuits which are needed to generate such high drive voltages are produced by manufacturers such as SHF Design Berlin (see product publication, Broadband Amplifier SHF 106P or SHF 103 CPA). But these drive amplifiers barely have a sufficient signal quality and are very cost-intensive. In addition, the cost of providing such a drive amplifier exceeds by several times the costs of providing an MZM modulator, which weakens the competitiveness of the optical communication system appreciably.

The object of the invention is to improve the amplitude modulation of an optical signal to the effect that the amplitude modulated optical transmission signal has a reduced carrier component. The object is achieved on the basis of a method according to the features of the preamble of patent claim 1 by the characterizing features thereof.

The critical aspect of the inventive method is that the optical signal is divided into first and second adjustable optical signals, and the first adjustable optical signal is supplied to the modulator, which emits the optical transmission signal subsequent to the amplitude modulation with the aid of the binary data signal. Furthermore, a second counter-phase optical signal is formed from the second adjustable optical signal, and the optical transmission signal and the second counter-phase optical signal are merged into a carrier-reduced optical transmission signal. With the carrier component of the amplitude modulated optical transmission signal being inventively reduced subsequent to the modulation of the first optical signal, a lower modulation voltage is needed in order to get a nearly fully modulated optical transmission signal. This makes it possible to employ electric drive amplifiers with a low drive voltage to drive the modulator, which are inexpensive and furthermore contribute to improving the signal quality of the transmission signal owing to the reduction of distortions in the optical transmission signal that is associated with the lower modulation voltage. The transmission range that can be bridged without regeneration can be advantageously increased by inventively reducing the carrier component by adapting the signal level as well as the phase position of the amplitude modulated optical transmission signal. The splitting the power of the optical signal into first and second adjustable optical signals by means of an adjustable cross-fade switch can be advantageously controlled with the aid of a first control signal (claim 2). Alternatively, the power of the optical signal can be split into first and second adjustable optical signals by means of a cross-fade switch exhibiting a fixed cross-fade ratio, whereby the power of the second adjustable optical signal is controllable by means of an adjustable optical attenuating element with the aid of the first control signal (claim 3). With the cross-fade switch which is inventively adjustable with the aid of a first control signal, or with the adjustable optical attenuating element, it is possible to adjust the carrier component of the amplitude modulated optical transmission signal far enough to be able to reduce the power of the carrier to nearly half the total power of the amplitude modulated optical transmission signal; that is, the total power of the amplitude modulated transmission signal is inventively distributed nearly evenly to the carrier and the two sidebands. Thus, a relatively low modulation voltage, for instance the data signal emitted by a multiplexer, is sufficient for fully modulating the optical signal for the purpose of generating the inventive carrier-reduced optical transmission signal.

The phase position of the counter-phase second optical signal is advantageously controllable by an adjustable phase control element with the aid of a second control signal (claim 4). This way, the phase position of the counterphase second optical signal is advantageously controllable for generating an exact 180° phase shift relative to the optical transmission signal. To that end, the setting of the phase shift is modified by “wobbling”, and controlling is performed according to the lock-in principle.

Advantageous developments of the inventive method, specifically a configuration for modulating the amplitude of an optical signal, are described in the remaining patent claims.

The invention will now be described in connection with three basic circuit diagrams and two signal flowcharts. Shown are

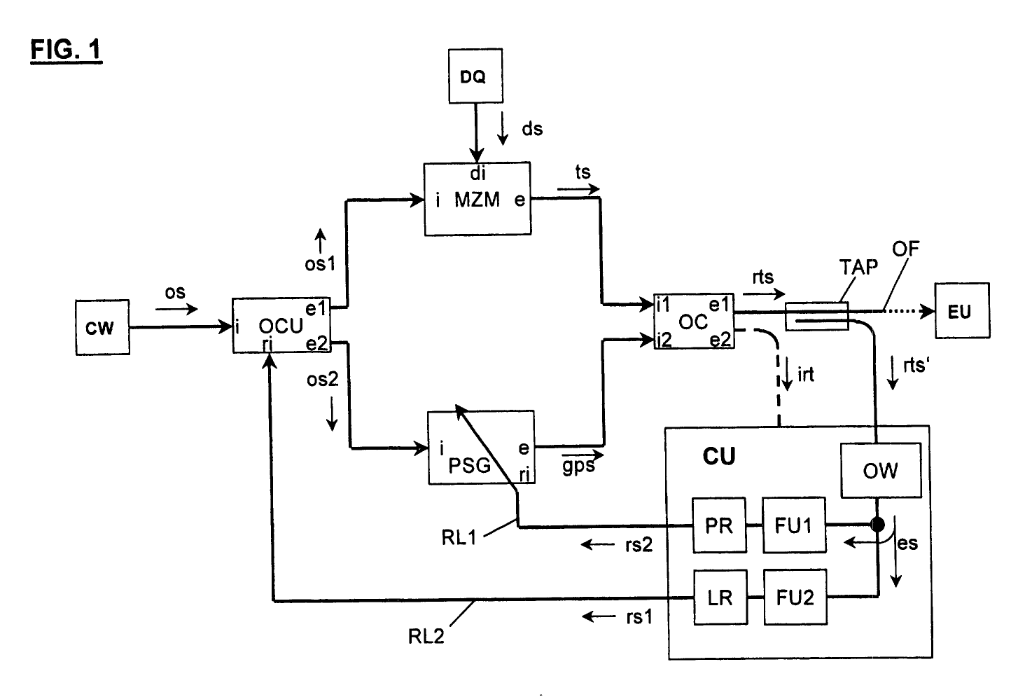

FIG. 1: the basic construction of the inventive configuration for amplitude modulation;

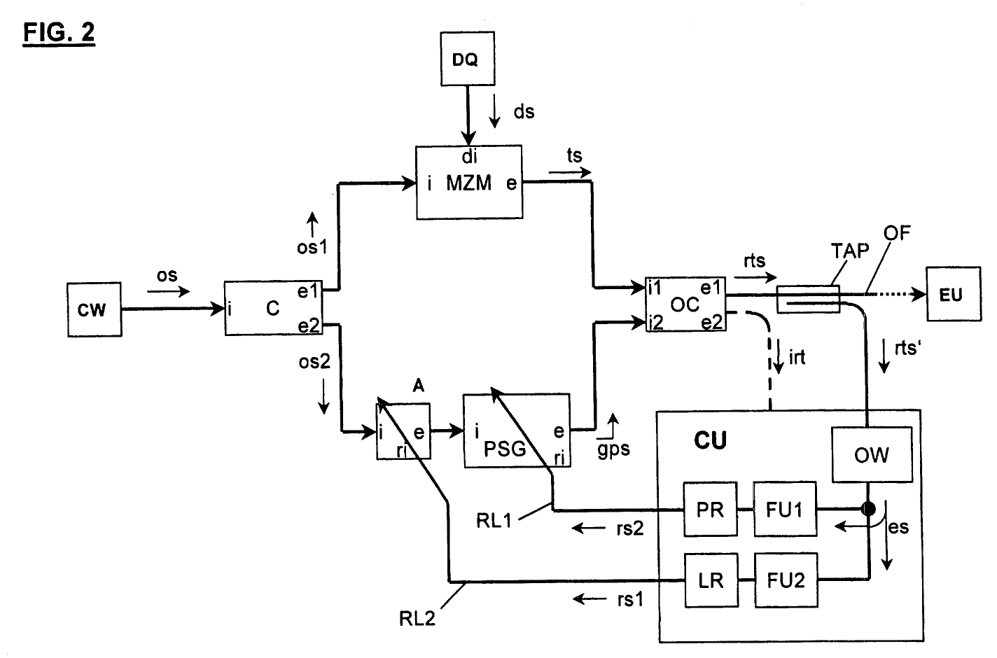

FIG. 2: another variant of the inventive configuration for amplitude modulation;

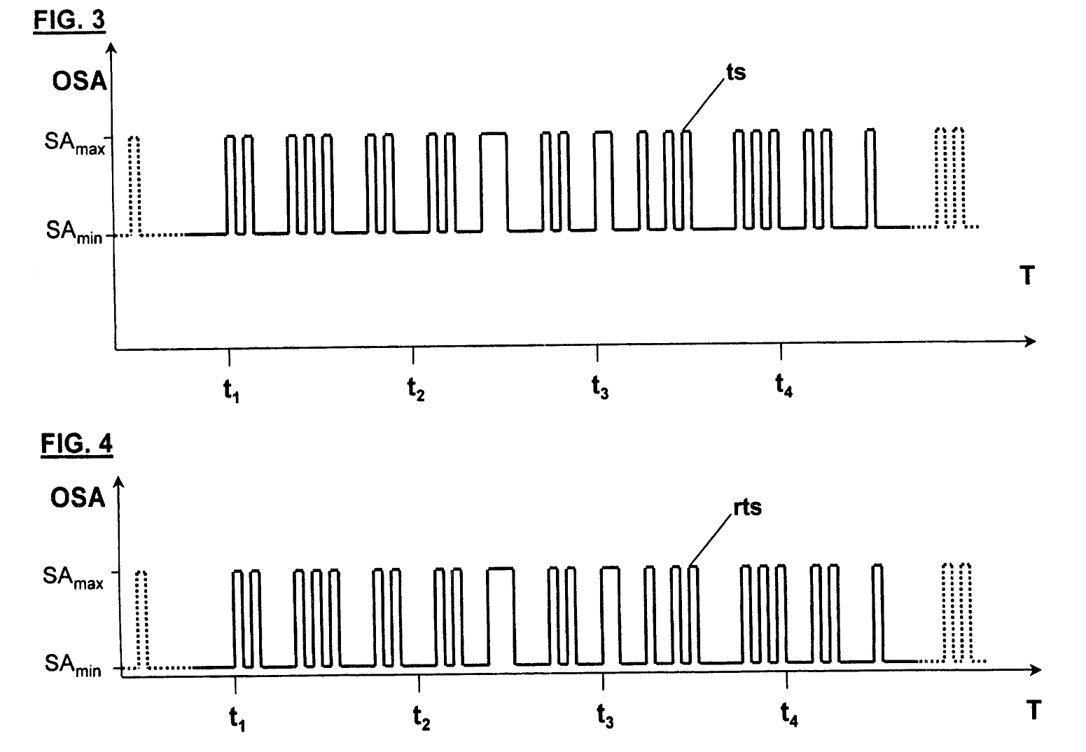

FIG. 3: an amplitude modulated optical transmission signal with a low extinction ratio, i.e. an excessively high carrier component;

FIG. 4: the inventively carrier-reduced optical transmission signal with a high extinction ratio; and

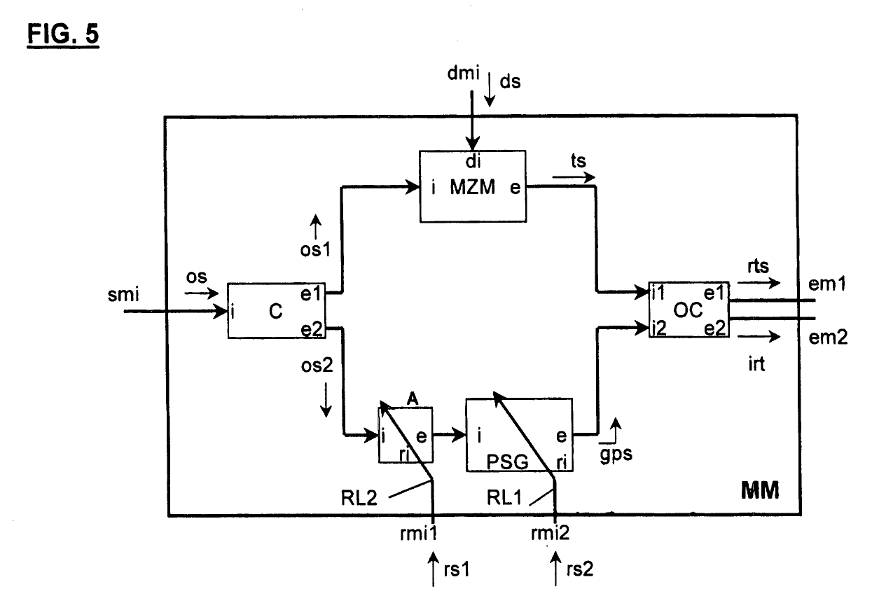

FIG. 5: the inventive configuration for amplitude modulation integrated in a modulator module.

FIG. 1 represents an example of a configuration for modulating the amplitude of an optical signal os with a binary data signal ds, comprising an adjustable phase control element PSG, an adjustable cross-fade switch OCU, a modulator MZM, a data source DQ, an optical coupler OC, an optical transmitting unit CW, and a control unit CU. The adjustable cross-fade switch OCU can be realized as an optical coupler with an adjustable cross-fade ratio, for example. The input i of the adjustable cross-fade switch OCU is connected to the optical transmission unit CW by a fiber-optic connection. The adjustable cross-fade switch OCU also comprises first and second outputs e1,e2 and a control input ri, whereby the first output e1 is connected to the input i of the modulator MZM, and the second output e2 is connected to the input i of the adjustable phase control element PSG. A Mach-Zehnder modulator can be provided as modulator MZM, which comprises an electrical data input di and an optical output e in addition to an optical input i, whereby the data input di is connected to a data source DQ, and the output e is connected to the first input i1 of the optical coupler OC. The adjustable phase control element PSG has an output e and a control input ri, whereby the output e of the adjustable phase element PSG is connected to the second input i2 of the optical coupler OC by a fiber-optic connection. The optical coupler OC comprises a first output e1 and a second output e2, whereby in FIG. 1 the first output e1 is connected by way of a TAP coupler TAP to a remote optical receiving unit EU, and the second output e2 is optionally connected to the control unit CU as indicated by a dotted line in FIG. 1. The optical TAP coupler TAP is connected to the control unit CU.

The control unit CU comprises an optical transducer OW, first and second filter units FU1,FU2, a phase controller PR, and a power controller LR. The optical transducer OW is connected to the TAP coupler TAP and the first and second filter units FU1,FU2, and the first filter unit FU1 is connected to the phase controller PR, which is connected to the control input ri of the adjustable phase control element PSG over a first control line RL1. The second filter unit FU2 is connected to the power controller LR, which is connected to the control input ri of the adjustable cross-fade switch OCU over a second control line R2.

An optical signal os is generated in the optical transmitting unit CW and emitted to the input i of the adjustable cross-fade switch OCU over a fiber-optic connection. With the aid of the adjustable cross-fade switch OCU, the optical signal os is split into first and second optical signals os1, os2 in consideration of the adjusted cross-fade ratio. The first optical signal os1 is carried to the first output e1 of the adjustable cross-fade switch OCU and supplied to the input i of the modulator MZM over a fiber-optic connection (i.e. an optical waveguide). The second optical signal os2 is emitted at the second output e2 of the adjustable cross-fade switch OCU and supplied to the input i of the adjustable phase control element PSG over another fiber-optic connection. With the aid of the data signal ds at the data input di, the amplitude of the first optical signal os1 is modulated in the modulator MZM, and thus an optical transmission signal ts is generated. The optical transmission signal ts is handed over to the first input i1 of the optical coupler OC at the output e of the modulator MZM over a fiber-optic connection. In the adjustable phase control element PSG, the second optical signal os2 is shifted by a predetermnined phase amount according to the phase shift amount that has been set. A phase shift amount in the range of 180° is preferably selected, in order to generate a counter-phase second optical signal gps at the output e of the adjustable phase control element PSG, particularly a signal which is counterphase with respect to the carrier component of the optical transmission signal ts. This counter-phase second optical signal gps is transmitted from output e of the adjustable phase control element PSG to the second input i2 of the optical coupler OC over an optical fiber.

With the aid of the optical coupler OC, the optical transmission signal ts and the counter-phase optical signal gps are superimposed, i.e. coupled, so that a carrier-reduced optical transmission signal rts emerges by destructive interference. The carrier-reduced optical transmission signal rts is driven onto the first output e1 of the optical coupler OC and from there over the optical TAP coupler TAP to the remote optical receiving unit EU, which is located a long distance away (indicated in FIG. 1 by a dotted communication fiber OF). An “inverted” optical signal irt is also generated in the coupling or superimposing of the optical transmission signal ts and the counter-phase second optical signal gps, whose carrier component has been increased relative to the optical transmission signal. With the optical superimposing (coupling) of the optical transmission signal ts with the counter-phase second optical signal gps, the carrier component of the optical transmission signal ts is reduced, whereby the extinction ratio (i.e. the ratio of the binary 1 signal power to the binary 0 signal power) of the carrier-reduced optical transmission signal rts is appreciably increased. In the ideal case, the carrier-reduced optical transmission signal rts has a carrier component of 50%, with the remaining 50% being information and data signal components which are distributed to the sidebands; that is, the power of the carrier corresponds to half the total signal power of the carrier-reduced optical transmission signal rts. Experts also refer to such a carrier-reduced optical transmission signal rts as a fully modulated transmission signal rts.

Furthermore, with the aid of the TAP coupler TAP, a portion (e.g. 10%) of the carrier-reduced optical transmission signal rts' is extracted and routed to a control unit CU, particularly the optical transducer OW, over an optical fiber. In the optical transducer OW the extracted portion of the carrier-reduced optical transmission signal rts' is transformed into an electrical signal es, which is driven to the first and second filter units FU1, FU2.

The first filter unit FU1 is constructed as a bandpass, whereby the passband of the bandpass has a bandwidth located at approximately half the data transmission rate. With the aid of the first filter unit FU1, the electrical signal es is filtered, and the result of the filtering is delivered to the phase controller PR. In the phase controller PR, the filtered electrical signal es is evaluated with respect to its signal amplitude or amplitude position, and a second control signal rs 2 for controlling the adjustable phase control element PSG with respect to the amount of phase shift is derived from the evaluation result. The second control signal is driven to the control input ri of the adjustable phase control element PSG over the first control line RL1. In this phase control process, the phase deviation, i.e. the operational sign of the phase deviation, of the counter-phase second optical signal os2 relative to the optical transmission signal ts is determined by “wobbling” (periodic varying of the phase shift by a small amount by means of wobble voltages), and with its aid a phase control is carried out in accordance with the lock-in principle. The phase position of the counter-phase second optical signal os2 is thus set by the adjustable phase control element PSG such that the measured amplitude of the electrical signal es assumes a maximum; i.e., the eye pattern of the carrier-reduced optical transmission signal rts has a maximal opening.

The second filter unit FU2 is realized as a lowpass with a low limit frequency, with the aid of which the power of the electrical signal es is determined. The result of the filtering by the second filter unit FU2 is delivered to the power controller LE. In the power controller LR, the power of the filtered electrical signal es is evaluated, and from the evaluation result a first control signal rs1 for controlling the adjustable cross-fade switch OCU is derived. The first control signal rs1 is transmitted to the control input ri of the adjustable optical cross-fade switch OCU over the second control line RL2. In this type of control, the measured signal power of the electrical signal es is controlled to a minimum, thereby reducing the carrier power component in the carrier-reduced optical transmission signal rts to half the total signal power of the carrier-reduced optical transmission signal rts.

FIG. 2 represents an additional embodiment of the inventive configuration for amplitude modulation, the adjustable optical cross-fade switch OCU in FIG. 1 having been replaced by an optical cross-fade switch C with a preset cross-fade ratio of 50:50, for example. The optical cross-fade switch C comprises an input e and a first and second output e1,e2, whereby the input e is connected to the optical transmitting unit CW, and the first output e1 is connected to the input i of the modulator MZM. An adjustable optical attenuating element A comprising an input i, a control input ri, and an output e is also provided in the additional embodiment of the configuration for amplitude modulation. The input i of the adjustable optical attenuating element A is connected to the second output e2 of the optical cross-fade switch C, and the output e of the adjustable optical attenuating element A is connected to the input i of the adjustable phase control element PSG. Furthermore, the control input ri of the adjustable optical attenuating element A is connected to the power controller LR of the control unit CU over the second control line RL2.

The mode of functioning of the configuration for amplitude modulation represented in FIG. 2 differs from the embodiment represented in FIG. 1 principally in that the optical cross-fade switch C splits the power of the optical signal os into first and second optical signals os1,os2 with the aid of the strictly prescribed cross-fade ratio. Controlling with respect to the power distribution between the carrier and signal components of the carrier-reduced optical transmission signal rts is carried out with the aid of the adjustable optical attenuating element A, which is connected to the power controller LR. Here, the attenuation amount of the adjustable optical attenuating element A is controlled with the aid of the first control signal rs1, for instance.

For purposes of illustrating the inventive reduction of the carrier component of the optical transmission signal ts, FIG. 3 represents a diagram of the amplitude modulated optical transmission signal ts comprising a low extinction ratio, and FIG. 4 represents a second diagram of the inventively carrier-reduced optical transmission signal rts with a high extinction ratio, whereby optical NRZ (No Return to Zero) signals have been selected to represent the optical transmission signals ts, rts in FIGS. 3 and 4. Furthermore, the diagrams represented in FIG. 3 and FIG. 4 each include a horizontal and vertical axis T,OSA, whereby the horizontal axis indicates the time progression T, and the vertical axis OSA indicates the amplitude OSA of the amplitude-modulated modulated optical transmission signal ts and of the carrier-reduced optical transmission signal rts. The amplitudes OSA of the amplitude modulated optical transmission signal ts and the carrier-reduced optical transmission signal rts respectively assume a maximum signal amplitude value SAₘₐₓ for a binary 1 and a minimum signal amplitude value SAₘᵢₙ for a binary 0. The amplitude modulated optical transmission signal ts represented in FIG. 3 inventively comprises a substantially higher maximum signal amplitude value SAₘₐₓ than the carrier-reduced optical transmission signal rts represented in FIG. 4. Similarly, the minimal signal amplitude value SAₘᵢₙ of the carrier-reduced optical transmission signal rts in FIG. 4 is substantially lower than that of the amplitude modulated optical transmission signal ts represented in FIG. 3. This directly evidences the inventive elevating of the extinction ratio in the carrier-reduced optical transmission signal rts, especially since the extinction of an optical transmission signal ts, rts is determined by forming the power ratio from the binary 1 power value and the binary 0 power value. The carrier-reduced optical transmission signal rts represented in FIG. 4 is thus a fully modulated optical transmission signal with respect to amplitude modulation, which can be transmitted to optical receiving unit EU at a distance of several 100 km without technical outlay for amplification or regeneration.

FIG. 5 represents a possible integration of the inventive configuration for amplitude modulation in a modulator module MM, which comprises an optical cross-fade switch UBS, a modulator MZM, an optical coupler OC, an adjustable attenuating element A, and an adjustable phase control element PSG. A signal input smi, a data input dmi, and first and second control inputs rmi1, rmi2 are provided for driving the modulator module MM, whereby the signal input smi is connected to the input e of the integrated optical cross-fade switch UBS; the data input dmi is connected to the data input di of the integrated modulator MZM; the first control input rmi is connected to control input ri of the adjustable optical attenuating element A; and the second control input rmi2 is connected to the control input ri of the adjustable phase control element PSG. Besides this, the modulator module MM exemplarily comprises first and second outputs em1, em2, whereby the first output em1 is connected to the first output e1 of the optical coupler OC, and the second output em2 is connected to the second output e2 of the optical coupler OC.

The mode of functioning of the modulator module MM represented in FIG. 5 is analogous to the additional configuration for amplitude modulation represented in FIG. 2, whereby the control of the adjustable optical attenuating element A and the adjustable phase control element PSG have not been integrated in the represented embodiment of the modulator module MM. Such integrating of the control into the modulator module MM or external controlling of the modulator module MM are realized in practice as needed.

Patent claims:

1. Method for modulating the amplitude of an optical signal (os) with a binary data signal (ds) which is supplied to a modulator (MZM) for the purpose of generating an optical transmission signal (ts),
characterized in that
the optical signal (os) is divided into a first and a second adjustable optical signal (os1,os2);
that the first adjustable optical signal (os1) is supplied to the modulator (MZM), which emits the optical transmission signal (ts) subsequent to the amplitude modulation with the binary data signal (ds);
that a second counter-phase optical signal (gps) is formed from the second adjustable optical signal (os2); and
that the optical transmission signal (ts) and the second counter-phase optical signal (gps) are merged into a carrier-reduced optical transmission signal (rts).

2. Method for amplitude modulation as claimed in claim 1,
characterized in that
the splitting of the power of the optical signal (os) into first and second optical signals (os1,os2) by an adjustable cross-fade switch (OCU) is controllable with the aid of a first control signal (rs1).

3. Method for amplitude modulation as claimed in claim 1,
characterized in that
the power of the optical signal (os) is divided into first and second adjustable optical signals (os1,os2) by a cross-fade switch (C) comprising a fixed cross-fade ratio, whereby the power of the second adjustable optical signal (os2) is controllable by an adjustable optical attenuating element (A) with the aid of the first control signal (rs1).

4. Method for amplitude modulation as claimed in claims 1 to 3,
characterized in that
the phase position of the counter-phase second optical signal (os2) is controllable by an adjustable phase control element (A) with the aid of a second control signal (rs2).

5. Method for amplitude modulation as claimed in claim 2 or 3,
characterized in that
in order to generate the first control signal (rs1), a portion of the carrier-reduced optical transmission signal (rts') is extracted and routed to a control unit (CU), in which the extracted portion of the carrier-reduced optical transmission signal (rts') is transformed into an electrical signal (es), whereupon the signal power of the electrical signal (es) is determined by filtering, and the first control signal (rs1) for controlling the adjustable cross-fade switch (OCU) or the adjustable attenuating element (A) is generated in dependence on the result of the power determination.

6. Method for amplitude modulation as claimed in claim 5,
characterized in that
in order to generate a second control signal (rs2) in the control unit (CU), a frequency band of the electrical signal (es) is filtered out, the amplitude of the filtered electrical signal (es) is determined, and the second control signal (rs2) for controlling the adjustable phase control element (PSG) is generated according to the lock-in principle in dependence on the result of the amplitude determination.

7. Configuration for modulating the amplitude of an optical signal (os) with a binary data signal (ds) by means of a modulator (MZM) at whose data input (di) the binary data signal (ds) is conducted and at whose output (e) an optical transmission signal (ts) is emitted,
characterized in that
an adjustable optical cross-fade unit (OCU) is provided for splitting the optical signal (os) into first and second adjustable optical signals (os1,os2);
a first output (e1) of the adjustable optical cross-fade unit (OCU) is connected to the input (i) of the modulator (MZM), and a second output (e2) is connected to the input (i) of an adjustable phase control element (PSG);
the output (e) of the modulator (MZM) and the output (e) of the phase control element (PSG) are connected to respective inputs (e1,e2) of a coupler unit (OC) at whose at least one output (e1) a carrier-reduced optical transmission signal (rts) is emitted;
a TAP coupler unit (TAP) is connected to the output (e1) of the coupler unit (OC) for the purpose of extracting a portion of the emitted carrier-reduced optical transmission signal (rts');
the TAP coupler unit (TAP) is connected to a control unit (CU) for the purpose of deriving at least one control signal (rs1, rs2) from the extracted portion of the carrier-reduced optical transmission signal (rts'); and
the control unit (CU) is connected to the adjustable phase control element (PSG) and the adjustable optical cross-fade unit (OCU) for purposes of controlling them.

8. Configuration for modulating the amplitude of an optical signal (os) with a binary data signal (ds) by means of a modulator (MZM) at whose data input (di) the binary data signal (ds) is conducted and at whose output (e) an optical transmission signal (ts) is emitted,
characterized in that
an optical cross-fade unit (C) is provided for splitting the optical signal (os) into first and second optical signals (os1,os2);
a first output (e1) of the optical cross-fade unit is connected to the input (i) of the modulator (MZM), and a second output (e2) is connected to the input (i) of an adjustable attenuating element (A);
the output (e) of the adjustable attenuating element (A) is connected to the input (i) of an adjustable phase control element (PSG);
the output (e) of the modulator and the output (e) of the adjustable phase control element (PSG) are connected to respective inputs (i1,i2) of a coupler unit (OC), at whose at least one output (e1) a carrier-reduced optical transmission signal (rts) is emitted;
a TAP coupler unit (TAP) is connected to the output (e1) of the coupler unit (OC) for purposes of extracting a portion of the emitted carrier-reduced optical transmission signal (rts');
the TAP coupler unit (TAP) is connected to a control unit (CU) for the purpose of deriving at least one control signal (rs1,rs2) from the extracted portion of the carrier-reduced optical transmission signal (rts'); and
the control unit (CU) is connected to the adjustable phase control element (PSG) and the adjustable attenuating element (A) for purposes of controlling them.

9. Configuration for amplitude modulation as claimed in claim 7,
characterized in that
the control unit (CU) is provided for generating at least one first control signal (rs I) for adjusting the dividing of the power of the optical signal (os) into first and second adjustable optical signals (os1,os2) by the adjustable optical cross-fade unit (OCU), or adjusting the attenuating of the second adjustable optical signal (os2) by the adjustable attenuating element (A).

10. Configuration for amplitude modulation as claimed in claims 7 to 9,
characterized in that
the control unit (CU) is provided for generating at least one second control signal (rs2) for controlling the amount of phase shift of the adjustable phase control element (PSG).

11. Configuration for amplitude modulation as claimed in claim 7 or 10,
characterized in that
an additional output (e2) of the coupler unit (OC) is connected to the control unit (CU), by way of which an inverted optical transmission signal (irt) is emitted to the control unit (CU).

12. Configuration for amplitude modulation as claimed in claims 7 tol 1,
characterized in that
an optical transducer (OW), first and second filter units (FU1,FU2) and at least one phase controller (PR) and one power controller (LR) are provided in the control unit (CU), whereby the extracted portion of the carrier-reduced optical transmission signal (rts') is transformed into an electrical signal (es) by the optical transducer (OW);
the electrical signal (es) is emitted to the first and second filter units (FU1,FU2);
the electrical signal (es) is filtered by the first filter unit (FU1) for purposes of amplitude measurement;
the electrical signal (es) is filtered by the second filter unit (FU2) for purposes of power measurement;
the first control signal (rs1) for controlling the adjustable cross-fade switch (OCU) or the adjustable attenuating element (A) is formed by the power controller (LR) in dependence on the measured power of the electrical signal (es); and
the second control signal (rs2) for controlling the adjustable phase control element (PSG) according to the lock-in principle is formed by the phase controller (PR) in dependence on the measured amplitude of the electrical signal (es).

13. Configuration for amplitude modulation as claimed in claims 7 to 12,
characterized in that
a Mach Zehnder modulator that is driven in a counter-phase configuration is provided as the modulator (MZM).

14. Configuration for amplitude modulation as claimed in claims 7 to 13,
characterized in that
the configuration for amplitude modulation is integrated in a modulator module (MM) comprising at least one signal input (smi), at least one data input (dmi), at least one control input (rmi1,rmi2), and at least one signal output (em1,em2).
